(19) United States
(12) Patent Application Publication
(10) Pub. No.: US 2026/0044160 A1
(43) Pub. Date: Feb. 12, 2026

(54) PRESSURE REDUCING VALVE, AND BIDET AND WATER PURIFIER COMPRISING SAME

(71) Applicants: COWAY CO., LTD., Gonju-si (KR); GGATE CO., LTD., Uiwang-si (KR)

(72) Inventors: Jae Hong LEE, Seoul (KR); Sung Worl JIN, Seoul (KR); Sung Hee LEE, Seoul (KR); Young Ju KIM, Seoul (KR); Woo Song JEON, Seoul (KR); Gyu Dong LEE, Uiwang-si (KR); Jyu Young LEE, Uiwang-si (KR)

(73) Assignees: COWAY CO., LTD., Gongju-si (KR); GGATE CO., LTD., Uiwang-si (KR)

(21) Appl. No.: 19/144,277

(22) PCT Filed: Dec. 20, 2023
(86) PCT No.: PCT/KR2023/021048

§ 371 Date: Jun. 27, 2025

(30) Foreign Application Priority Data
Dec. 29, 2022 (KR) 10-2022-0189604

(51) Int. Cl. G05D 16/06; C02F 1/00; E03D 9/08

(52) U.S. Cl. CPC G05D 16/0652; C02F 1/003; E03D 9/08; C02F 2201/005; C02F 2307/10

(57) ABSTRACT

The present invention relates to a pressure reducing valve and to a bidet and a water purifier comprising same. In particular, the pressure reducing valve, according to one embodiment of the present invention, comprises: a valve body that provides a water inlet, a water outlet, a drain port for draining water to the outside, and a communication flow channel which provides a passage for water introduced from the inlet to flow to the outlet or the drain port; a plunger that operates so as to be in a discharge state which allows water introduced from the inlet to flow to the outlet or in a blocking state which blocks water introduced from the inlet from flowing to the outlet; an operating rod that selectively communicates the inlet and the outlet by selectively coming into close contact with the communication flow channel; and a sub-diaphragm that selectively communicates the inlet and the drain port by selectively coming into close contact with the operating rod according to the pressure of water introduced from the inlet. The pressure reducing valve may be in a normal open state and a safe operating state depending on the condition of the sub diaphragm.

### TECHNICAL FIELD

The present disclosure relates to a pressure reducing valve, and to a bidet and a water purifier including the same.

### BACKGROUND ART

In general, a pressure reducing valve is a device that reduces pressure of a fluid such as water, high-pressure steam, air, or gas, and allows a high-pressure fluid to be discharged while reducing its pressure or maintaining a constant pressure. The pressure reducing valve can perform pressure reduction in response to varying pressures by utilizing an elastic member and a diaphragm.

Conventional pressure reducing valves have function of regulating the flow of fluid according to the pressure of the fluid at inlet and outlet sides, but have a problem in that they cannot control the flow of fluid when a large amount of fluid flows into the inlet side. In order to add function of controlling the flow of fluid, a configuration for controlling the flow of fluid needs to be added, but there is a problem in that the structure of the pressure reducing valve becomes complicated and the overall volume of the pressure reducing valve may become excessively large.

In this regard, Korean Patent Application Publication No. 10-2006-0103060 entitled “Pressure reducing valve device having flow path blocking function” (Patent Document 1) discloses a valve body providing a first chamber connected to an inlet, a second chamber connected to an outlet, and a communication hole connecting the first chamber and the second chamber, a pressure regulating body for controlling a flow rate of fluid moving through the communication hole according to the pressure of the first chamber, and an operating rod that regulates the pressure in the first chamber.

However, the pressure reducing valve device disclosed in Patent Document 1 has a problem in that when a large amount of fluid is instantaneously introduced through the inlet, the pressure regulating body instantaneously blocks the flow into the second chamber, which may lead to an increase in internal pressure of the pressure reducing valve device. In other words, when a large amount of fluid flows in through the inlet and the fluid flowing into the second chamber is blocked, the internal pressure of the pressure reducing valve device may instantaneously increase to a high-pressure state, and repeated pressure changes inside the pressure reducing valve device may deteriorate the durability of the pressure reducing valve device.

In addition, Korean Patent Application Publication No. 10-2017-0077977 entitled “Pressure reducing valve device having flow path blocking function” (Patent Document 2) discloses a valve body having a first chamber connected to an inlet and a second chamber connected to an outlet, a second diaphragm that moves up and down in response to pressure changes in the second chamber, an operating rod that regulates the pressure in the first chamber, and a first diaphragm that controls the flow rate of a fluid.

However, the pressure reducing valve device disclosed in Patent Document 2, although capable of maintaining a constant flow rate of fluid discharged through the outlet, has a drawback in that even when a large amount of fluid is temporarily introduced through the inlet due to a malfunction of a fluid supply valve, only a fixed amount of fluid can be discharged through the outlet. In other words, when fluid is temporarily introduced through the inlet and only the fixed amount of fluid is discharged through the outlet, the internal pressure of the pressure reducing valve device may rise to a high-pressure state, and repeated pressure changes inside the pressure reducing valve device may cause damage to the components downstream of the pressure reducing valve device.

### DETAILED DESCRIPTION OF INVENTION

### Technical Problems

Embodiments of the present disclosure have been devised in view of the above background, and provide a pressure reducing valve capable of, when the pressure of incoming water rises above a predetermined pressure, draining an excessive amount of incoming water to the outside, and a bidet and a water purifier including the same.

### Technical Solution

In accordance with one embodiment of the present disclosure, a pressure reducing valve comprises: a valve body providing an inlet for introduction of water, an outlet for discharge of water, a drain port for draining water to the outside, and a communication passage providing a passage for water introduced through the inlet to flow to the outlet or the drain port; a plunger that operates to be placed in a discharge state in which water introduced through the inlet is allowed to flow to the outlet or a blocking state in which water introduced through the inlet is blocked from flowing to the outlet; an operating rod that selectively comes into close contact with the communication passage to selectively allow communication between the inlet and the outlet; and a sub-diaphragm which selectively comes into close contact with the operating rod depending on a pressure of water introduced through the inlet to selectively allow communication between the inlet and the drain port, wherein when the plunger is placed in the discharge state, the sub-diaphragm is placed in a normal open state in which water is blocked from flowing to the drain port and allowed to flow to the outlet, or in a safe operating state in which water is allowed to flow to the drain port and the outlet.

Further, the sub-diaphragm may be in the normal open state when the pressure of water introduced through the inlet is equal to or less than a predetermined pressure and the water introduced through the inlet is allowed to flow to the outlet, and may be in the safe operating state when the pressure of water introduced through the inlet is greater than the predetermined pressure and the water introduced through the inlet is allowed to flow to the outlet.

Further, the pressure reducing valve may further comprise a main diaphragm interposed between the plunger and the operating rod to regulate a flow rate of water flowing through the communication passage, wherein the main diaphragm may be in close contact with the plunger in the blocking state and is separated from the plunger in the discharge state.

Further, the main diaphragm may include an elastically deformable material.

Further, the pressure reducing valve may further comprise a first elastic member that applies elastic force to the operating rod such that in the blocking state, the operating rod is pressed against the communication passage to block the communication between the inlet and the outlet.

Further, the pressure reducing valve may further comprise a second elastic member that applies elastic force to the sub-diaphragm such that in the blocking state or the normal open state, the sub-diaphragm may be pressed against the operating rod to block the communication between the inlet and the drain port.

Further, in the safe operating state, the sub-diaphragm may be moved to form a gap between the operating rod and the sub-diaphragm so that water may be drained through the drain port.

Further, the sub-diaphragm may include an elastically deformable material.

Further, a rod flow path, which is a passage through which water flows, may be formed inside the operating rod, and the rod flow path may guide water to the drain port through a gap formed between the operating rod and the sub-diaphragm to be drained in the safe operating state.

Further, when the pressure of water introduced through the inlet is in a range of 0.5 kg/cm² to 8.0 kg/cm², the sub-diaphragm may be placed in the safe operating state when the plunger is placed in the discharge state.

Further, a distance between a position of the operating rod in the blocking state and a position of the operating rod in the safe operating state may be greater than a distance between the position of the operating rod in the blocking state and a position of the operating rod in the normal open state.

Further, a distance between a position of the sub-diaphragm in the blocking state and a position of the sub-diaphragm in the safe operating state may be greater than a distance between a position of the operating rod in the blocking state and a position of the operating rod in the normal open state.

Further, a relative movement distance between the sub-diaphragm and the operating rod when the blocking state is switched to the normal open state may be smaller than a relative movement distance between the sub-diaphragm and the operating rod when the blocking state is switched to the safe operating state.

Further, a bidet may comprise: the pressure reducing valve; and a nozzle for receiving water from the pressure reducing valve and discharging water toward a user.

Further, a water purifier comprise: the pressure reducing valve; and a filter for filtering water supplied from the pressure reducing valve to provide purified water.

### Effect of Invention

According to one embodiment of the present disclosure, in the discharge state in which water introduced through the inlet can flow to the outlet, the pressure reducing valve can operate either the normal open state which allows water to flow to the outlet, or the safe operating state which allows water to flow to both the drain port and the outlet, so that even when fluid flows in through the inlet at excessive pressure, water can be diverted and drained through the drain port, thereby preventing the water from being discharged through the outlet at an unnecessarily high pressure.

Further, according to one embodiment of the present disclosure, when the internal pressure of the pressure reducing valve increases due to the inflow of a large amount of water, the water can be diverted and drained through the drain port, thereby preventing damage to components inside the pressure reducing valve or damage to components downstream of the pressure reducing valve due to high pressure.

Furthermore, according to one embodiment of the present disclosure, the pressure reducing valve can maintain the normal open state or the safe operating state depending on the pressure of the water introduced through the inlet, thereby allowing the fluid introduced through the inlet to smoothly flow to the outlet or the drain port.

In addition, according to one embodiment of the present disclosure, the flow of water introduced through the inlet to the outlet can be tightly blocked by bringing the plunger into close contact with the main diaphragm, and the flow of water introduced through the inlet to the outlet can be reliably permitted by separating the plunger from the main diaphragm.

Further, according to one embodiment of the present disclosure, by manufacturing the main diaphragm and the sub-diaphragm from elastically deformable materials, the flow of water can be flexibly controlled in response to changes in the movement of the plunger or variations in the pressure of the water.

Furthermore, according to one embodiment of the present disclosure, by elastically supporting the operating rod through a plurality of elastic members, the operating rod can be pressed against the outlet side of the communication passage in the blocking state, thereby effectively blocking communication between the inlet and the outlet.

In addition, according to one embodiment of the present disclosure, by elastically supporting the sub-diaphragm through the first elastic member and the second elastic member, the sub-diaphragm can be brought into close contact with the operating rod the blocking state or the normal open state to effectively blocking communication between the inlet and drain, and the sub-diaphragm can be separated from the operating rod in the safe operating state to allow communication between the inlet and drain port.

Further, according to one embodiment of the present disclosure, in the safe operating state, a gap is formed between the operating rod and the sub-diaphragm, thereby allowing water to be drained through the gap between the operating rod and the sub-diaphragm and the drain port.

Furthermore, according to one embodiment of the present disclosure, by configuring the distance between the position of the operating rod in the blocking state and the position of the operating rod in the safe operating state to be greater than the distance between the position of the operating rod in the blocking state and the position of the operating rod in the normal open state, the flow rate of water flowing to the outlet in the safe operating state may be greater than the flow rate of water flowing to the outlet in the normal open state, thereby maintaining a smooth flow of water within the pressure reducing valve.

In addition, according to one embodiment of the present disclosure, by configuring the distance between the position of the sub-diaphragm in the blocking state and the position of the sub-diaphragm in the safe operating state to be greater than the distance between the position of the operating rod in the blocking state and the position of the operating rod in the normal open state, water can be smoothly drained from the drain port through the gap formed between the operating rod and the sub-diaphragm in the safe operating state.

### BRIEF DESCRIPTION OF THE DRAWINGS

FIG. 1 is a side view of a bidet to which a pressure reducing valve is applied.

FIG. 2 is a cross-sectional view of the pressure reducing valve.

FIG. 3 is a side view of an operating rod of the pressure reducing valve.

FIG. 4 is a cross-sectional view of the pressure reducing valve in a normal open state in which water flows to an outlet.

FIG. 5 is an enlarged view of part “A” in FIG. 4.

FIG. 6 is a cross-sectional view of the pressure reducing valve in a safe operating state in which water flows to both the outlet and a drain port.

FIG. 7 is an enlarged view of part “B” in FIG. 6.

FIG. 8 is a side view of a water purifier to which the pressure reducing valve is applied.

### MODE FOR CARRYING OUT THE INVENTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

The meaning of “including” used in the present specification specifies specific features, regions, integers, steps, operations, elements and/or components, and does not exclude the presence or addition of other specific features, regions, integers, steps, operations, elements, components, and/or groups.

Hereinafter, a bidet will be described with reference to the drawings.

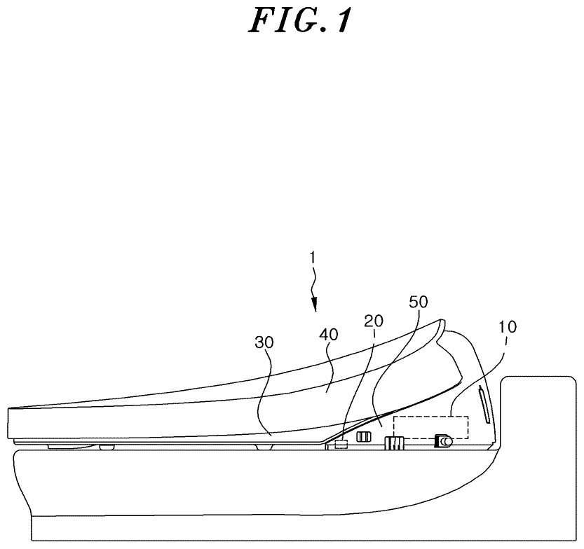

Referring to FIG. 1, in one embodiment of the present disclosure, a bidet 1 is capable of spraying cleaning water toward a user to clean the user's body. Even when water at a pressure higher than a predetermined pressure flows into a pressure reducing valve 10, the bidet 1 can drain the water if pressure reduction fails.

The bidet 1 may include a pressure reducing valve 10, a nozzle 20, a toilet seat 30, a cover 40, and a bidet body 50.

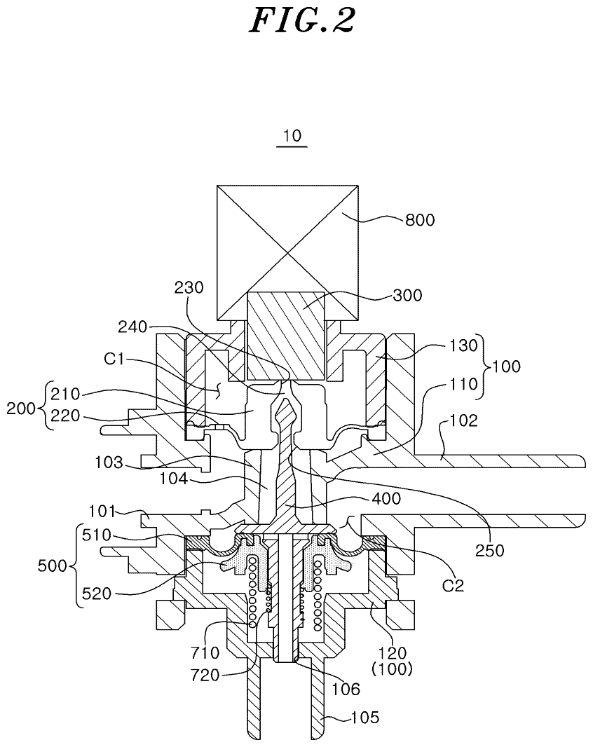

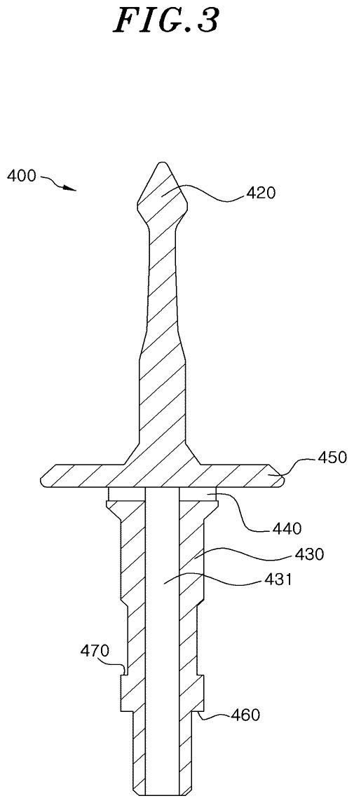

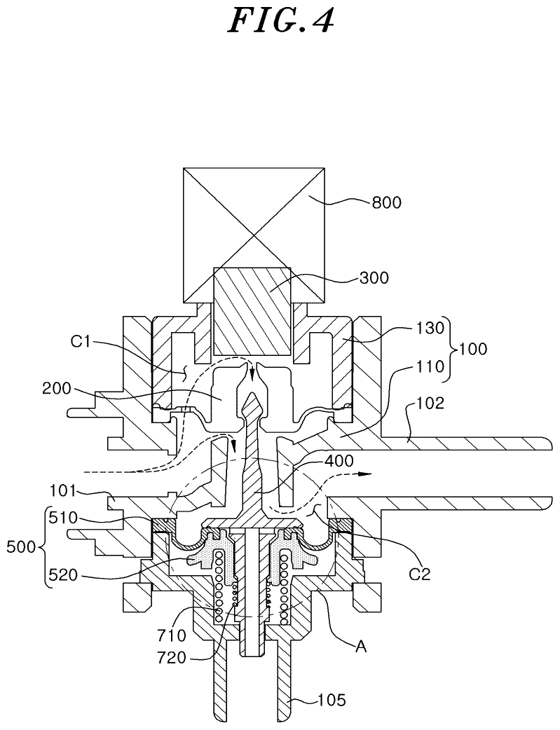

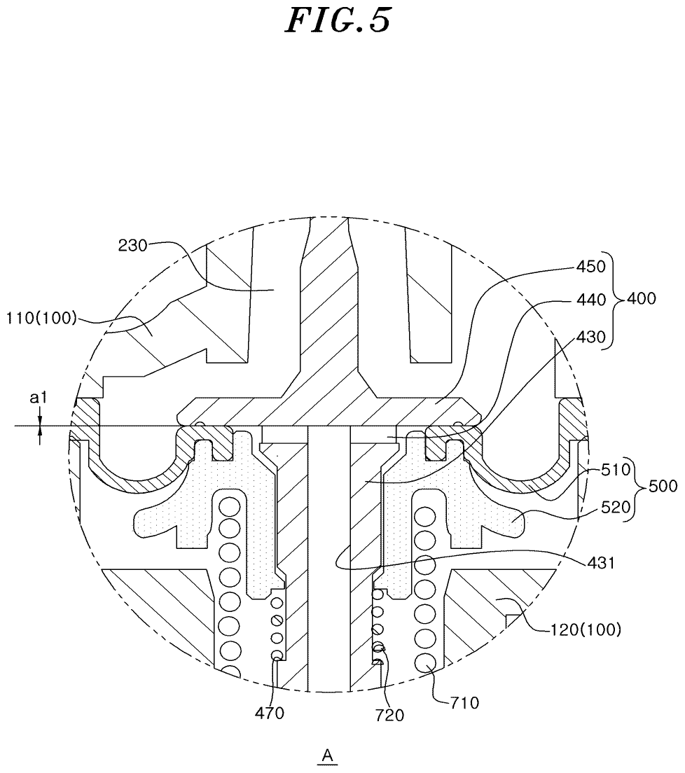

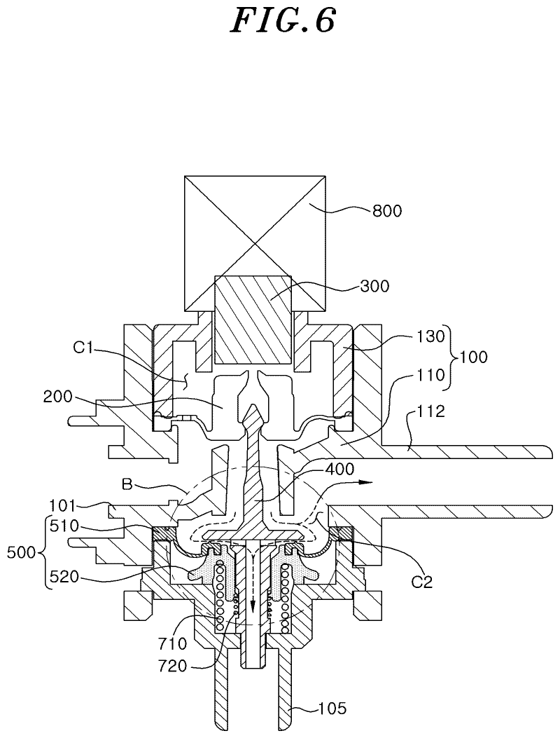

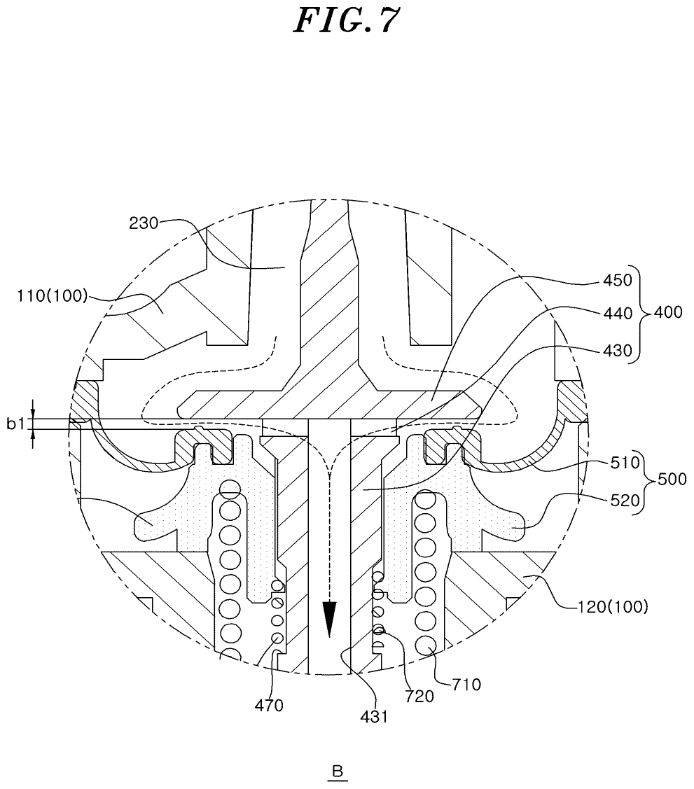

Referring to FIGS. 2 to 7, the pressure reducing valve 10 can provide water to the nozzle 20 or drain water to the outside depending on changes in the pressure of the incoming water. The pressure reducing valve 10 may include a valve body 100, a main diaphragm 200, a plunger 300, a sub-diaphragm 500, a first elastic member 710, and a second elastic member 720.

The valve body 100 may support the main diaphragm 200, the plunger 300, the sub-diaphragm 500, the first elastic member 710, and the second elastic member 720. Inside the valve body 100, pressure reduction of water can be performed in response to changes in the pressure of the water. The valve body 100 may have an inlet 101, an outlet 102, a drain port 105, and a communication passage 104. The inlet 101 may be a passage of the valve body 100 for the introduction of water. The inlet 101 may be formed on one side of the valve body 100. The outlet 102 may be a passage for the discharge of water. The outlet 102 may be formed on the other side of the valve body 100. The drain port 105 may be a passage for draining water to the outside. The drain port 105 may be formed at a lower portion of the valve body 100. The communication passage 104 may be a passage for guiding water introduced through the inlet 101 to the outlet 102 or the drain port 105. The communication passage 104 may be provided by a flow path guide 103 formed at the center of the valve body 100.

The valve body 100 may be formed by assembling three parts. For example, the valve body 100 may include a valve body part 110, a safety valve part 120, and a plunger support part 130. The valve body part 110 may support the main diaphragm 200 and the plunger support part 130. The plunger support part 130 may be assembled to an upper portion of the valve body part 110. The safety valve part 120 may be assembled to a lower portion of the valve body part 110. The valve body part 110 may be formed with the inlet 101, the outlet 102, the flow guide 103, and the communication passage 104. A second chamber C2 may be formed in the lower portion of the valve body part 110. The second chamber C2 may be a space provided between the communication passage 104 and the outlet 102.

The safety valve part 120 may support the sub-diaphragm 500, the first elastic member 710, and the second elastic member 720. In other words, an upper edge portion of the safety valve part 120 may support the edge of the sub-diaphragm 500, and a lower bottom portion of the safety valve part 120 may support the first elastic member 710. The safety valve part 120 may be assembled to the lower portion of the valve body part 110. A drain hole 106, through which a lower end portion of the operating rod 400 passes, may be formed in a lower center portion of the safety valve part 120. The drain port 105 communicating with the drain hole 106 may be formed in a lower portion of the safety valve part 120.

The plunger support part 130 may support the plunger 300 to be movable up and down. The plunger support part 130 may be assembled to the upper portion of the valve body part 110. An actuator 800 for moving the plunger 300 up and down may be disposed on an upper portion of the plunger support part 130. A first chamber C1 may be formed in a lower portion of the plunger support part 130. The first chamber C1 may be a space formed between a bottom surface of the plunger support part 130 and the main diaphragm 200. In the present embodiment, the valve body part 110, the safety valve part 120, and the plunger support part 130 may be assembled to form a single valve body 100, but the present disclosure is not limited thereto, and the valve body 100 may be formed as a single integral structure.

The main diaphragm 200 may be disposed between the plunger 300 and the operating rod 400. The main diaphragm 200 may be formed of an elastically deformable material. The main diaphragm 200 can regulate the flow rate of water flowing in the communication passage 104. When the plunger 300 is placed in a blocking state, an upper portion of the main diaphragm 200 may be in close contact with the lower portion of the plunger 300. When the plunger 300 is placed in a discharge state, the upper portion of the main diaphragm 200 may be separated from the plunger 300.

The main diaphragm 200 may include a main diaphragm body 210 and a main diaphragm inlet hole 220. An outlet hole 230 may be formed in the upper portion of the main diaphragm body 210, through which water introduced through the inlet hole 220 can flow. When the plunger 300 is placed in the blocking state, the outlet hole 230 may be blocked by the plunger 300, and when the plunger 300 is placed in the discharge state, the outlet hole 230 may be opened by the plunger 300. Inside the main diaphragm body 210, an outlet passage 240 communicating with the outlet hole 230 may be formed to extend in an up-down direction. A discharge port 250 may be formed in the lower portion of the main diaphragm body 210, on which a rod valve portion 420 of the operating rod 400 can be caught. The discharge port 250 may have an inner diameter smaller than an inner diameter of the outlet passage 240 so that the rod valve portion 420 can be caught on the discharge port 250.

The plunger 300 can be operated to be in the discharge state or the blocking state. The discharge state is a state in which water introduced through the inlet 101 can flow into the communication passage 104 through the main diaphragm 200, and the blocking state is a state in which water introduced through the inlet 101 cannot flow into the communication passage 104 by the plunger 300 and the main diaphragm 200. When the plunger 300 is in close contact with the main diaphragm 200, the plunger 300 can be in the blocking state. When the plunger 300 is separated from the main diaphragm 200, the plunger 300 can be in the discharge state.

The plunger 300 can be moved up and down by the operation of the actuator 800. The actuator 800 can provide a driving force to move the plunger 300 up and down. For example, the actuator 800 may be an electromagnet that can move the plunger 300 up and down using electromagnetic force, or an actuating cylinder that can move the plunger 300 up and down using mechanical force.

The operating rod 400 may be arranged to be movable in the up-down direction in the communication passage 104. The operating rod 400 can selectively allow communication between the inlet 101 and the outlet 102 by selectively coming into close contact with the lower portion (outlet) of the communication passage 104. In other words, the operating rod 400 can selectively open and close the communication passage 104 in response to changes in water pressure to selectively regulate the flow of water between the inlet 101 and the outlet 102.

The operating rod 400 may include a rod valve portion 420, a rod drain portion 430, a rod communication portion 440, a rod flange portion 450, a rod stop stepped portion 460, and a rod support stepped portion 470. The rod valve portion 420 may be formed at an upper portion of the operating rod 400 so that it can be inserted into the outlet passage 240 of the main diaphragm 200. The rod valve portion 420 may have an outer diameter larger than the inner diameter of the discharge port 250 so that it may be caught on the discharge port 250 of the main diaphragm 200.

The rod flange portion 450 may have a flange shape extending horizontally from a central portion of the operating rod 400. The rod flange portion 450 may have an outer diameter larger than the inner diameter of the communication passage 104. When the operating rod 400 moves up and down in the communication passage 104, the rod flange portion 450 can selectively open and close the lower portion (outlet) of the communication passage 104.

When a gap is formed between the rod flange portion 450 and the sub-diaphragm 500, the rod drain portion 430 can guide water flowing in the communication passage 104 to the drain port 105. A rod flow path 431 that can be in communication with the drain port 105 may be formed inside the rod drain portion 430. In a safe operating state, the rod flow path can guide water to the drain port 105 through the gap formed between the operating rod 400 and the sub-diaphragm 500.

The rod stop stepped portion 460 may be formed at a lower portion of the rod drain portion 430 to limit the maximum downward movement distance of the operating rod 400. When the operating rod 400 moves downward, the rod stop stepped portion 460 may be caught on the drain hole 106 of the safety valve part 120 through which the operating rod 400 passes, thereby limiting the downward movement of the operating rod 400. The outer diameter of the rod stop stepped portion 460 may be larger than the inner diameter of the drain hole 106 so that the rod stop stepped portion 460 can be caught on the drain hole 106.

The rod support stepped portion 470 may be formed to protrude from the lower portion of the rod drain portion 430 to support the second elastic member 720. The rod support stepped portion 470 may protrude horizontally from the lower portion of the rod drain portion 430 to provide a support space that supports the lower end of the second elastic member 720.

The sub-diaphragm 500 can come into close contact with the rod flange portion 450 of the operating rod 400 or be separated from the rod flange portion 450 depending on the pressure of water introduced through the inlet 101. The sub-diaphragm 500 may include an elastically deformable diaphragm part 510 and a support ring part 520 that supports the diaphragm part 510. An edge portion of the diaphragm part 510 may be fixed to the valve body part 110 and the safety valve part 120. The support ring portion 520 may support an inner edge portion of the diaphragm part 510. A lower portion of the support ring portion 520 may be elastically supported by a first elastic member 710 and a second elastic member 720.

When the sub-diaphragm 500 is in close contact with the rod flange portion 450, water passing through the communication passage 104 cannot be guided to the drain port 105 through the operating rod 400. When the sub-diaphragm 500 is separated from the rod flange portion 450, water passing through the communication passage 104 can be guided to the drain port 105 through the gap formed between the sub-diaphragm 500 and the rod flange portion 450 and the operating rod 400.

The sub-diaphragm 500 may be in a normal open state when the plunger 300 is in the discharge state. The normal open state may be a state in which, when the plunger 300 is in the discharge state and the pressure of water introduced through the inlet 101 is equal to or less than a predetermined pressure, water passing through the communication passage 104 is blocked from flowing to the drain port 105 and allowed to flow to the outlet 102. In the normal open state, the sub-diaphragm 500 may allow water to flow to the outlet 102 while blocking water from flowing to the drain port 105.

The sub-diaphragm 500 may be placed in the safe operating state when the plunger 300 is placed in the discharge state. The safe operating state may be a state in which water passing through the communication passage 104 is allowed to flow to the drain port 105 and the outlet 102 when the pressure of introduced water while the plunger 300 is placed in the discharge state is greater than the predetermined pressure. For example, when the pressure of water introduced through the inlet 101 is in the range of 0.5 kg/cm² to 8.0 kg/cm², the sub-diaphragm 500 can be placed in the safe operating state when the plunger 300 is placed in the discharge state. In the safe operating state, the sub-diaphragm 500 can form a gap between the operating rod 400 and the sub-diaphragm 500 to allow water to drain to the drain port 105 and can also allow water to flow to the outlet 102.

The first elastic member 710 can provide elastic force to the operating rod 400 and the sub-diaphragm 500. The first elastic member 710 may support the lower part of the sub-diaphragm 500 while being supported by the safety valve part 120 of the valve body 100. When the plunger is in the blocking state, the first elastic member 710 can apply elastic force to the operating rod 400 through the sub-diaphragm 500 to press the operating rod 400 against the outlet side of the communication passage 104. When the operating rod 400 is pressed against the outlet side of the communication passage 104, the communication between the inlet 101 and the outlet 102 can be blocked.

The second elastic member 720 can provide elastic force to the sub-diaphragm 500. The second elastic member 720 may support the lower part of the sub-diaphragm 500 while being supported by the support stepped portion of the operating rod 400. When the plunger is in the blocking state, or in the normal open state while the plunger is in the discharge state, the second elastic member 720 can apply elastic force to the sub-diaphragm 500 to bring the sub-diaphragm 500 into close contact with the operating rod 400. When the sub-diaphragm 500 comes into close contact with the operating rod 400, the communication between the inlet 101 and the drain port 105 can be blocked.

The nozzle 20 can spray cleaning water toward a user. The nozzle 20 can receive water at a certain pressure from the pressure reducing valve 10 and spray the supplied water as cleaning water toward the user.

The toilet seat 30 may provide a portion on which a user can sit. The toilet seat 30 may be provided to be rotatable with respect to the bidet body 50. The toilet seat 30 may be supported on at least a portion of a toilet bowl. The toilet seat 30 may be covered and protected by the cover 40.

The cover 40 can open and close the interior of the toilet bowl with respect to the outside. The cover 40 may be provided to be rotatable with respect to the bidet body 50. The cover 40 may be connected to a rotation axis to be rotatable with respect to the bidet body 50. The cover 40 can be rotated about the rotation axis between a closed position and an open position with respect to the toilet bowl.

The bidet body 50 can support components of the bidet. The bidet components such as the pressure reducing valve 10 and the nozzle can be accommodated inside the bidet body 50. The bidet body 50 may be detachably fixed to the toilet bowl.

Hereinafter, the blocking state and the discharge state (normal open state and safe operating state) of the pressure reducing valve will be described in more detail.

In the blocking state of the pressure reducing valve 10, that is, when the plunger 300 is in the blocking state, the plunger 300 can be moved downward toward the main diaphragm 200. When the plunger 300 is moved downward toward the main diaphragm 200, the outlet hole of the main diaphragm can be blocked by the plunger 300, and the gap between the main diaphragm and the inlet side of the communication passage 104 can also be blocked. In this state, water introduced through the inlet 101 cannot flow into the communication passage 104 due to the blockage formed by the plunger 300 and the main diaphragm 200.

In the discharge state of the pressure reducing valve 10, that is, when the plunger 300 is in the discharge state, the plunger 300 can be moved upward and positioned at its original position. When the plunger 300 is moved upward and separated from the main diaphragm 200, the outlet hole of the main diaphragm can be opened, and the gap between the main diaphragm and the inlet side of the communication passage 104 can also be opened. In this state, water introduced through the inlet 101 can flow into the communication passage 104 through the main diaphragm 200 and through the gap between the main diaphragm and the inlet side of the communication passage 104.

When the plunger 300 is in the discharge state and the pressure of the water introduced through the inlet 101 is equal to or less than the predetermined pressure, that is, in the normal open state, the water passing through the communication passage 104 is blocked from flowing to the drain port 105, but is allowed to flow through the outlet 102. When the pressure of the water is reduced to be equal to or less than the predetermined pressure, the entire amount of water introduced through the inlet 101 can be discharged through the outlet 102. The predetermined pressure may vary depending on the type/elasticity of the elastic member, etc. In the normal open state, the sub-diaphragm 500 is pressed against the rod flange portion 450 by the elastic forces of the first elastic member 710 and the second elastic member 720, so that no gap al is formed between the rod flange portion 450 of the operating rod 400 and the sub-diaphragm 500, and therefore water passing through the communication passage 104 cannot flow to the drain port 105 to be drained.

When the plunger 300 is in the discharge state and the pressure of water introduced through the inlet 101 is greater than the predetermined pressure, that is, in the safe operating state, water passing through the communication passage 104 can flow simultaneously through the drain port 105 and the outlet 102. For example, the predetermined pressure may be in the range of 0.5 kg/cm² to 8.0 kg/cm².

When the pressure of water introduced through the inlet 101 becomes greater than the predetermined pressure, the operating rod 400 can move downward due to the pressure of the water greater than the predetermined pressure, and the sub-diaphragm 500 can also move downward, overcoming the elastic forces of the first elastic member 710 and the second elastic member 720. When the operating rod 400 moves downward, the stop stepped portion of the operating rod 400 is caught by the drain hole 106 and stops further movement, but the sub-diaphragm 500 moves further than the moving distance of the operating rod 400 and stops, so that a gap bl can be formed between the rod flange portion 450 of the operating rod 400 and the sub-diaphragm 500. Water passing through the communication passage 104 flows to the drain port 105 through the gap bi formed between the rod flange portion 450 and the sub-diaphragm 500 to be drained.

Meanwhile, the distance between the position of the operating rod 400 in the blocking state and the position of the operating rod 400 in the safe operating state may be greater than the distance between the position of the operating rod 400 in the blocking state and the position of the operating rod 400 in the normal open state. The amount of water passing through the communication passage 104 and discharged through the outlet 102 in the safe operating state may be greater than the amount of water passing through the communication passage 104 and discharged through the outlet 102 in the normal open state.

In addition, the distance between the position of the sub-diaphragm 500 in the blocking state and the position of the sub-diaphragm 500 in the safe operating state may be greater than the distance between the position of the operating rod 400 in the blocking state and the position of the operating rod 400 in the normal open state. In other words, the relative movement distance between the sub-diaphragm 500 and the operating rod 400 when the blocking state is switched to the normal open state may be smaller than the relative movement distance between the sub-diaphragm 500 and the operating rod 400 when the blocking state is switched to the safe operating state. Further, the sub-diaphragm 500 can be moved downward further relative to the operating rod 400 when the blocking state is switched to the safe operating state. In the safe operating state, water passing through the communication passage 104 can flow to the drain port 105 through the gap bi formed between the rod flange portion 450 and the sub-diaphragm 500 to be drained.

Hereinafter, the operation and effects of the pressure reducing valve will be described in more detail.

In the discharge state in which water introduced through the inlet 101 is allowed to flow to the outlet 102, the pressure reducing valve 10 can be in the normal open state in which water is allowed to flow to the outlet 102, or in the safe operating state in which water is allowed to flow to the drain port 105 and the outlet 102, so that when the internal pressure of the pressure reducing valve 10 increases due to the introduction of a large amount of water, the water can be diverted and drained through the drain port 105. In other words, even when the internal pressure of the pressure reducing valve 10 increases due to the introduction of a large amount of water, the water can be diverted and drained through the drain port 105, so that damage to components inside the pressure reducing valve 10 or damage to components downstream of the pressure reducing valve due to high pressure can be prevented.

Further, in the pressure reducing valve 10, when the plunger 300 is in close contact with the main diaphragm 200, water introduced through the inlet 101 can be tightly blocked from flowing to the outlet 102, and when the plunger 300 is separated from the main diaphragm 200, water introduced through the inlet 101 can be reliably allowed to flow to the outlet 102.

Furthermore, since the main diaphragm 200 and the sub-diaphragm 500 are configured to be elastically deformable, the flow of water can be flexibly controlled in response to changes in the movement of the plunger 300 or changes in the pressure of the water.

In addition, the sub-diaphragm 500 is elastically supported by the first elastic member 710 and the second elastic member 720, so that in the blocking state or the normal open state, the sub-diaphragm 500 can be brought into close contact with the operating rod 400 to effectively block communication between the inlet 101 and the drain port 105, and in the safe operating state, the sub-diaphragm 500 can be separated from the operating rod 400 to allow communication between the inlet 101 and the drain port 105.

Further, in the safe operating state, a gap is formed between the operating rod 400 and the sub-diaphragm 500, so that water can be drained through the gap between the operating rod 400 and the sub-diaphragm 500 and through the drain hole 105.

Meanwhile, in one embodiment of the present disclosure, a bidet 1 is capable of spraying cleaning water toward a user to clean the user's body. Even when fluid at a pressure higher than a predetermined pressure flows into a pressure reducing valve 10, the water purifier 2 can divert and drain the water. The water purifier 2 may include a pressure reducing valve 10, a water purifier body 60, a filter 70, and a dispensing faucet 80.

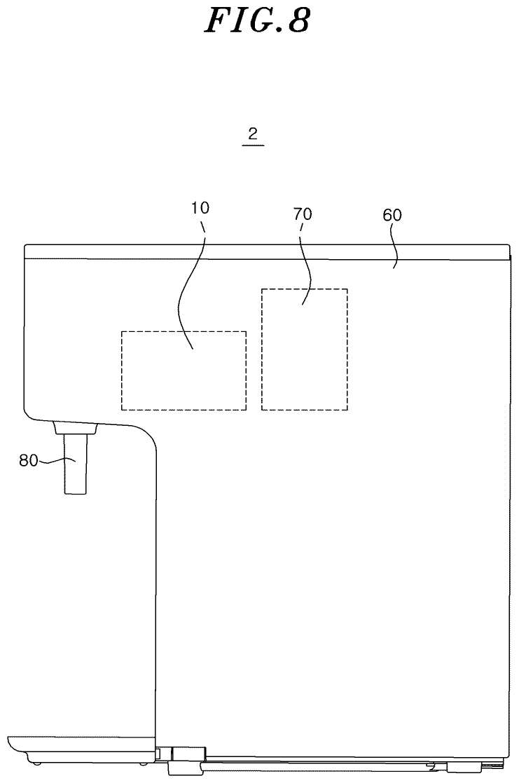

Referring to FIG. 8, the pressure reducing valve 10 may be accommodated inside the water purifier body. The pressure reducing valve 10 can provide water or drain water to the outside depending on changes in pressure of the incoming water. Since the pressure reducing valve 10 corresponds to the configuration of the pressure reducing valve 10 applied to the bidet 1 described above, the description thereof will be omitted.

The water purifier body 60 may support components of the water purifier. The components of the water purifier, such as the pressure reducing valve 10, the filter 70, and the dispensing faucet 80, may be arranged in the water purifier body 60. The filter 70 can filter raw water introduced into the water purifier 2 to produce purified water. The dispensing faucet 80 allows purified water filtered through the filter 70 to be dispensed to the outside.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

What is claimed is:

1. A pressure reducing valve comprising:
a valve body providing an inlet for introduction of water, an outlet for discharge of water, a drain port for draining water to the outside, and a communication passage providing a passage for water introduced through the inlet to flow to the outlet or the drain port;
a plunger that operates to be placed in a discharge state in which water introduced through the inlet is allowed to flow to the outlet or a blocking state in which water introduced through the inlet is blocked from flowing to the outlet;
an operating rod that selectively comes into close contact with the communication passage to selectively allow communication between the inlet and the outlet; and
a sub-diaphragm which selectively comes into close contact with the operating rod depending on a pressure of water introduced through the inlet to selectively allow communication between the inlet and the drain port,
wherein when the plunger is placed in the discharge state, the sub-diaphragm is placed in a normal open state in which water is blocked from flowing to the drain port and allowed to flow to the outlet, or in a safe operating state in which water is allowed to flow to the drain port and the outlet.

2. The pressure reducing valve of claim 1, wherein the sub-diaphragm is in the normal open state when the pressure of water introduced through the inlet is equal to or less than a predetermined pressure and the water introduced through the inlet is allowed to flow to the outlet, and is in the safe operating state when the pressure of water introduced through the inlet is greater than the predetermined pressure and the water introduced through the inlet is allowed to flow to the outlet.

3. The pressure reducing valve of claim 1, further comprising a main diaphragm interposed between the plunger and the operating rod to regulate a flow rate of water flowing through the communication passage,
wherein the main diaphragm is in close contact with the plunger in the blocking state and is separated from the plunger in the discharge state.

4. The pressure reducing valve of claim 3, wherein the main diaphragm includes an elastically deformable material.

5. The pressure reducing valve of claim 1, further comprising a first elastic member that applies elastic force to the operating rod such that in the blocking state, the operating rod is pressed against the communication passage to block the communication between the inlet and the outlet.

6. The pressure reducing valve of claim 1, further comprising a second elastic member that applies elastic force to the sub-diaphragm such that in the blocking state or the normal open state, the sub-diaphragm is pressed against the operating rod to block the communication between the inlet and the drain port.

7. The pressure reducing valve of claim 1, wherein in the safe operating state, the sub-diaphragm is moved to form a gap between the operating rod and the sub-diaphragm so that water is drained through the drain port.

8. The pressure reducing valve of claim 1, wherein the sub-diaphragm includes an elastically deformable material.

9. The pressure reducing valve of claim 1, wherein a rod flow path, which is a passage through which water flows, is formed inside the operating rod, and
the rod flow path guides water to the drain port through a gap formed between the operating rod and the sub-diaphragm to be drained in the safe operating state.

10. The pressure reducing valve of claim 1, wherein when the pressure of water introduced through the inlet is in a range of 0.5 kg/cm² to 8.0 kg/cm², the sub-diaphragm is placed in the safe operating state when the plunger is placed in the discharge state.

11. The pressure reducing valve of claim 1, wherein a distance between a position of the operating rod in the blocking state and a position of the operating rod in the safe operating state is greater than a distance between the position of the operating rod in the blocking state and a position of the operating rod in the normal open state.

12. The pressure reducing valve of claim 1, wherein a distance between a position of the sub-diaphragm in the blocking state and a position of the sub-diaphragm in the safe operating state is greater than a distance between a position of the operating rod in the blocking state and a position of the operating rod in the normal open state.

13. The pressure reducing valve of claim 12, wherein a relative movement distance between the sub-diaphragm and the operating rod when the blocking state is switched to the normal open state is smaller than a relative movement distance between the sub-diaphragm and the operating rod when the blocking state is switched to the safe operating state.

14. A bidet comprising:
the pressure reducing valve according to claim 1; and
a nozzle for receiving water from the pressure reducing valve and discharging water toward a user.

15. A water purifier comprising:
the pressure reducing valve according to claim 1; and
a filter for filtering water supplied from the pressure reducing valve to provide purified water.
